(19) United States
(12) Patent Application Publication
(10) Pub. No.: US 2008/0160489 A1
(43) Pub. Date: Jul. 3, 2008

(54) Method For the Prediction of the Course of a Catheter

(75) Inventor: Johannes Bruijns, Grave (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,637

(22) PCT Filed: Feb. 20, 2006
(86) PCT No.: PCT/IB2006/050547

§ 371 Date: Aug. 20, 2007

(30) Foreign Application Priority Data
Feb. 23, 2005 (EP) 05101378.7

(51) Int. Cl. G09B 23/30

(52) U.S. Cl. 434/272

(57) ABSTRACT

The invention relates to a method for the prediction of the course of a catheter between a starting and a target location in a vessel system. According to a preferred embodiment, a micro-catheter will be modeled by a micro-catheter tube (MT) following a micro-catheter center line (MC) through the vessel system, wherein said center line is composed of an alternating sequence of straight-lined sections and curved sections. The curved sections are introduced at locations where the micro-catheter tube contacts the vessel wall and/or turns into a side branch of the vessel system.

The invention relates to a method for the prediction of the course of a (micro-) catheter within a vessel system, a method for the manufacture of a catheter, a data processing unit for the execution of the prediction method, and a record carrier with a program executing the prediction method.

The success of catheter interventions in the vascular system of a patient can be improved if they can be planned and prepared with the help of suited modeling procedures. Said procedures typically require a three-dimensional geometrical model of the patient's vessel system, which may for example be acquired by means of 3D rotational angiography. A typical example of a catheter intervention is the treatment of an aneurysm, wherein methods for a fully-automatic labeling of aneurysm voxels in modeled 3D vessel systems have been described in literature (cf. J. Bruijns: “Fully-automatic labelling of aneurysm voxels for volume estimation”, Proc. Bildverarbeitung fuer die Medizin, pages 51-55, Erlangen, Germany, March 2003). After the labeling of an aneurysm, a treatment plan has to be developed by the physician including the selection of a catheter with appropriate qualities, for example diameter and elasticity.

Based on this situation it was an object of the present invention to provide means for an assisted and improved planning of catheter interventions.

This object is achieved by a method according to claim 1, a method according to claim 9, a data processing unit according to claim 10, and a record carrier according to claim 11.

According to a first aspect, the invention relates to a method for the prediction of the course of a catheter between a given starting location (for example the incision where the catheter is introduced into the body) and a given target location (for example an aneurysm) in a modeled vessel system. The term “catheter” shall in principle comprise any oblong instrument that can be advanced through the vascular system of a patient. The course of the catheter is described by a tubular object called “course tube”, wherein said tube runs along an associated “course center line” leading from the starting location to the target location. The method comprises the following steps:

a) The determination of a path through the vessel system leading from the starting location to the target location, and the identification of an initial course center line with said path. If the vessel system is for example modeled by a tubular object with a center line, the path may follow said vessel center line.
b) The adjustment of the aforementioned initial course center line in such a way that the course tube associated with this center line lies within the vessel system. Preferably the resulting course tube will fulfill further (optimization) criteria, too, for example have a configuration that minimizes bending energy.

With a method of the aforementioned kind it is possible to improve and automate the planning of an intervention in the vascular system, because the course of a catheter introduced into said system can be predicted individually for the vessel system. This helps the physician to decide upon the feasibility of an intervention and the best way to execute it. Moreover, the method helps to select and possibly prepare the best suited type of catheter for the particular task.

In a first application of the proposed method, the course tube may be a “corridor tube” that describes a corridor within which a catheter may run from the starting to the target location through the vessel system. An intervention is feasible if the corridor is large enough to receive the catheter while still leaving space for a residual blood flow.

In a second application of the proposed method, the course tube may be a “micro-catheter tube” that describes the shape of a micro-catheter running from the starting to the target location through the vessel system. The designation “micro-catheter” shall indicate that this application is particularly suited for small, slender catheters. The term is however not meant as a limitation and shall in principle comprise any oblong instrument that can be advanced through the vascular system of a patient.

In a combination of the aforementioned applications, a corridor tube is determined first, and a micro-catheter tube is determined next in such a way that it lies within said corridor tube. During the determination of the micro-catheter tube, the path through the vessel system required in step a) of the method is preferably defined as the center line of the corridor tube.

In a preferred embodiment of the invention, the micro-catheter center line comprises an alternating sequence of straight-lined sections and curved sections. For the straight-lined sections, the associated tube section lies by definition in the interior of the vessel system (i.e. everywhere a distance away from the walls of the vessel system); for the curved sections, on the contrary, the associated tube section touches the vessel walls (without penetrating into the surrounding tissue of the vessel system) and/or makes a turn into a side branch of the vessel system. As indicated by their names, the straight-lined sections are preferably (approximately) straight, while the curved sections are bent. A sequence of straight-lined and curved sections is particularly suited for the description of thin, slender micro-catheters which extend straightly until they contact a vessel wall or must have a turn to enter a branch of the vessel system.

The aforementioned sequence of straight-lined and curved sections may particularly be determined in an iterative way, for example beginning with a straight-lined section at the starting location. During the iteration, the straight-lined sections will then be extended until the introduction of a curved section becomes necessary to bring the micro-catheter back into the interior of the vessel system or to enter a side branch.

In a preferred embodiment of the aforementioned approach, each iteration step comprises the following sub-steps:

aa) The determination of a “catheter corner”. Said catheter corner is defined as (i) the intersection of the straight-lined section currently considered in the iteration step with the vessel wall surrounding this straight-lined section or as (ii) the point on the current straight-lined section lying at the same distance from the start of said section as the farthest vessel wall of the side branch which the micro-catheter follows (whichever of the alternatives (i), (ii) is nearer). The catheter corner therefore indicates the point of the vessel system at which the straight course of the current straight-lined section must end.
bb) The shifting of a point of the current straight-lined section that is close (perhaps closest) to the catheter corner by an initial “shift vector” towards the catheter corner determined in step aa). Typically this point will be shifted to the catheter corner as close as possible with respect to boundary conditions (e.g. the necessity that the micro-catheter tube remains inside the vessel system).
cc) The introduction of a transition from the current straight-lined section to the following curved section at the aforementioned shifted point of the current straight-lined section. The course of the curved section must then be determined according to given boundary conditions.

In a preferred continuation of the aforementioned iteration method, the following curved section introduced in step cc) is consecutively and piece by piece shifted in the direction of the initial shift vector of step bb), wherein the shifting length is decreased monotonously in such a way that the associated micro-catheter tube only touches the wall of the vessel system without penetrating it. The monotonous reduction of the shift length avoids local meanders of the micro-catheter tube. Moreover, the following straight-lined section will start at the point where the micro-catheter tube shifted with the current shift length loses contact to the vessel wall for the first time. In other words, the micro-catheter center line is shifted as much as is required by the vessel walls, and it turns into the next straight-lined section where the micro-catheter tube can again run freely inside the interior of the vessel system.

The tubes or tubular objects that are used in the methods described above (for example the micro-catheter tube or the corridor tube) are preferably described by a series of probes, wherein each probe comprises a sphere with a center and an associated plane. The center of said sphere lies on the center line of the modeled tube, and the associated plane contains said center and runs orthogonal to the center line of the tube. Moreover, the probes may be characterized by further parameters, for example radii of an elliptic cross section corresponding to the cross section of the tube.

The invention further relates to a method for the manufacture of a catheter, preferably a micro-catheter, comprising the following steps:

a) The prediction of the course of the catheter during an intended intervention with a method of the aforementioned kind.
b) The preparation, preferably the pre-molding, of the catheter in accordance with the predicted course.

With this method a (micro-)catheter can be individually designed for a particular intervention and a particular patient. This facilitates the intervention substantially, makes difficult cases treatable, and reduces the risk of complications.

The invention further relates to a data processing unit which is adapted to execute a prediction method of the kind described above. The data processing unit may comprise the usual computer components like central processing unit, storage, I/O interfaces and the like together with associated computer programs.

Finally, the invention comprises a record carrier, for example a floppy disk, a hard disk, or a compact disc (CD), on which a computer program for the prediction of the course of a catheter according to a method of the aforementioned kind is stored.

These and other aspects of the invention will be apparent from and elucidated with reference to the embodiment(s) described hereinafter.

In the following the invention is described by way of example with the help of the accompanying drawings in which:

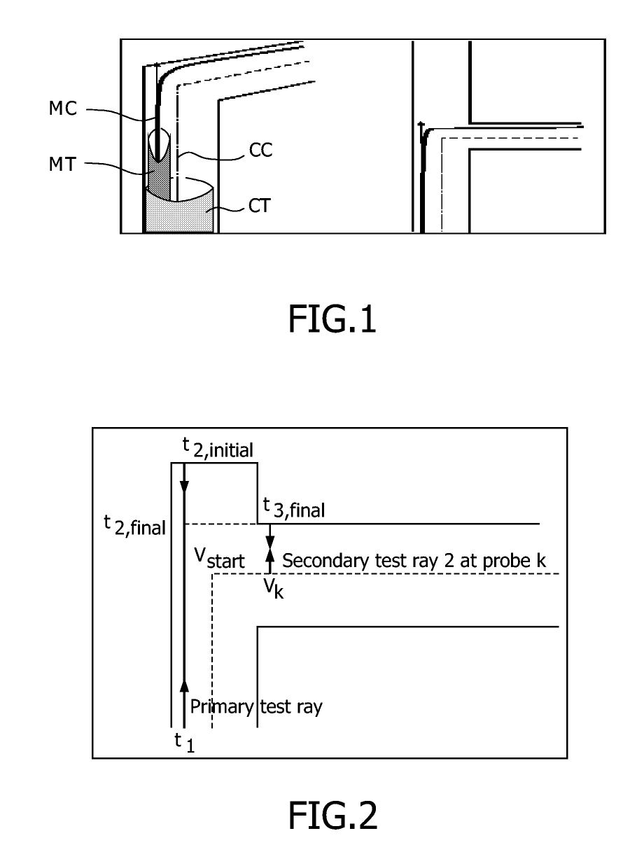

FIG. 1 schematically shows a corridor tube CT and a micro-catheter tube MT together with their central lines CC and MC, respectively, within a bent section of a vessel system (left) and a branching section of a vessel system (right);

FIG. 2 illustrates the determination of a catheter corner at a side branch of the vessel system, wherein a straight-lined section will transit into a curved section at said catheter corner;

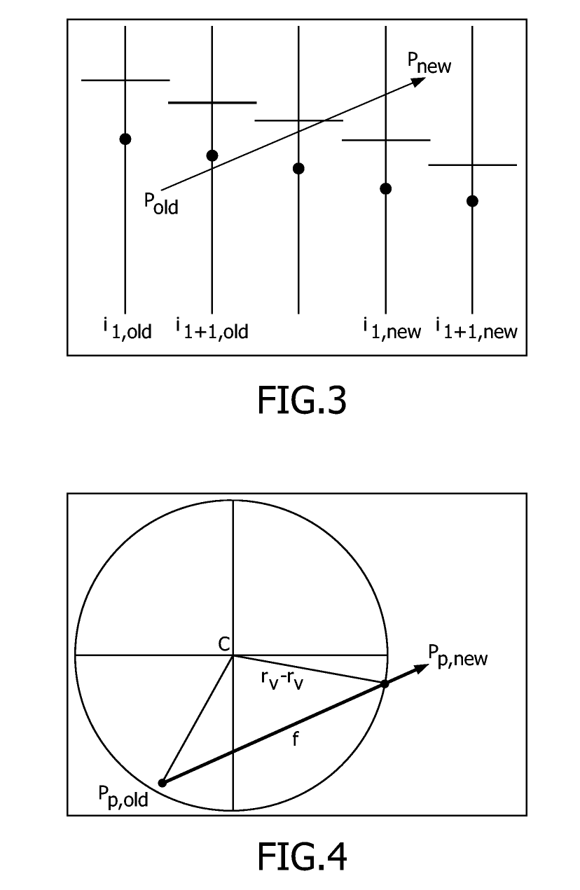

FIG. 3 illustrates the shift of a micro-catheter probe from location p_{old} to location p_{new} in a curved section, wherein the dots represent the centers of probes describing the corresponding corridor tube in this region;

FIG. 4 illustrates the projection of the shift vector of FIG. 3 onto the plane of a corridor tube probe for the calculation of the maximal shift vector length;

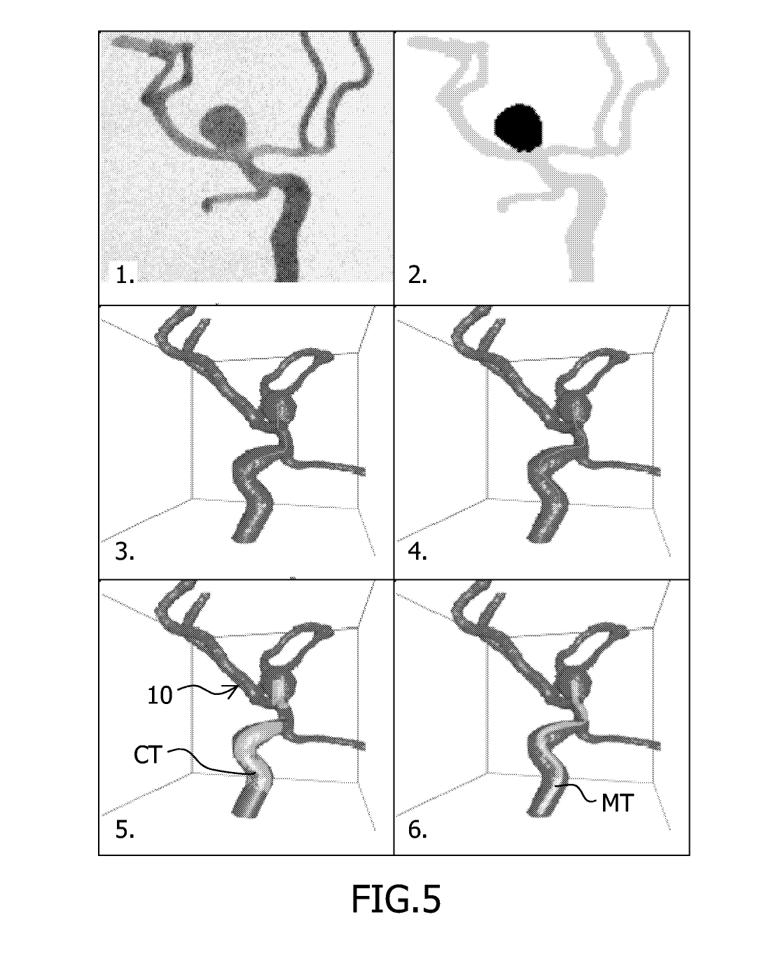

FIG. 5 shows different three-dimensional representations of a vessel system with an aneurysm, namely:
1. top left: the gray value volume;
2. top right: the labelled volume, wherein the aneurysm is marked in black;
3. middle left: the central curve of a corridor tube;
4. middle right: the central curve of a micro-catheter tube;
5. bottom left: the surface of a corridor tube;
6. bottom right: the surface of a micro-catheter tube.

The following description of the Figures and of a preferred embodiment of the invention quotes an article prepared by the inventors.

### 1. INTRODUCTION

Volume representations of blood vessels, acquired by means of 3D rotational angiography [4, 5], have a clear distinction in gray values (a gray value indicates the amount of X-ray absorption) between tissue (tissue is everything except vessels) and vessel voxels. Therefore, these volume representations are very suitable for diagnosing an aneurysm, a local omnidirectional widening of a vessel (see FIG. 5.1). In [3] we described a method for fully-automatic labelling of the aneurysm voxels (see FIG. 5.2).

A modeled vessel system as it will be used here preferably comprises the following components (cf. [1], [2], [3]):

1. A 3D volume model (like the scalar model) with for each point of the regular 3D grid an indication whether this point belongs to the vessel or not, and in case of a vessel point whether it is a “normal” vessel point or a point in an aneurysm, and in case of a “normal” vessel point to which branch or junction (“bifurcation”) the point belongs.
2. A surface model describing the boundary between vessel and non-vessel. Each vertex of this surface model should not only have a position, but also a normal and a label indicating whether the vertex is part of the aneurysm boundary or to which branch or junction part it belongs.
3. A graph describing the relation between the junctions and the branches.

After an aneurysm is labelled, the next step is to create a treatment plan. A physician may treat an aneurysm by first moving a catheter inside the aneurysm and next injecting coils or glue through the catheter into the aneurysm. We model the corridor through the vessels for a catheter by a “corridor tube” (see FIG. 5.5). The central curve of a corridor tube represents the central curve through the corridor vessels. The diameters of a corridor tube represent the diameters of the corridor vessels. A corridor tube may be used to select the catheter with the right qualities (e.g. the diameter, the elasticity). Computation of the corridor tube is described in Section 2.

Before an aneurysm can be filled via a catheter, a micro-catheter is moved via the vessels into the aneurysm. A micro-catheter is a very slender object compared to the vessels. So, the central curve of a corridor tube differs from the central curve of a micro-catheter. Indeed, a micro-catheter will more or less follow the walls of the vessels, crossing when a vessel bends back (compare FIG. 5.3 with FIG. 5.4). Because a micro-catheter is selected and pre-molded for easy movement into the aneurysm, we developed a method to compute the shape of a micro-catheter from a corridor tube. Computation of the shape of the micro-catheter is described in Section 3.

### 2. THE CORRIDOR TUBE

Physicians may treat an aneurysm by first moving a catheter inside the aneurysm and next injecting coils or glue through the catheter into the aneurysm. We model the corridor through the vessels for a catheter by a “corridor tube”. The central curve of a corridor tube represents the central curve through the corridor vessels. The diameters of a corridor tube represent the diameters of the corridor vessels. A corridor tube may be used to select the catheter with the right qualities (e.g. the diameter, the elasticity). Indeed, the smallest diameter of the corridor tube gives an upper limit for the catheter. The difference between the smallest cross-sectional area of the corridor tube and the selected catheter is an indication for the leftover flow capacity. Note that filling of the aneurysm via the corridor tube is not simulated.

In our system a tube object (tube for short) consists of a series of probes [1]. A probe is a combination of a sphere, a plane through the center of the sphere and a number of shape parameters. If the tube is created by fully-automatic vessel tracing [2], the sphere center of each probe will be close to the central axis of the vessel, the plane of each probe will be almost orthogonal to the vessel and the shape parameters of each probe include an ellipse approximating the local cross-section. We use the ellipses of the probes as approximate description of the tube surface.

A corridor tube consists of two parts: the vessel tube and the extension tube. The vessel tube represents the corridor through the “normal” vessel parts. The extension tube represents the corridor from the end of the vessel tube into the aneurysm.

The start and end position of the corridor tube are created by launching two probes. First, the user selects a point on the 2D image of the surface of a “normal” vessel part connected to the aneurysm. Next, our system moves the first probe to the vessel voxel on the central axis closest to the view ray through the selected surface point. After that, the user selects a point on the surface of the aneurysm. The view ray through this second point defines a line segment between the front and the back of the aneurysm. The second probe is moved to the vessel voxel closest to the center of this line segment. After the start and end position are selected, the corridor tube is created by the following algorithm:

1. Find the aneurysm neck closest (i.e. with the shortest path along “normal” vessel parts) to the first probe. An aneurysm neck is the connection between the aneurysm and a “normal” vessel part and may for instance be modeled by a connected set of “normal” vessel voxels (called “neck voxels”) in which each “normal” vessel voxel is face connected to at least one aneurysm voxel. It is possible for an aneurysm to have more than one neck, namely if there exist two or more disjunct connected sets of neck voxels.
2. Generate the vessel tube by fully-automatic vessel tracing [2] from the first probe to the center of this neck. This tube is refined as follows:
(a) The central curve of the tube (i.e. the centers of the spheres of the probes) is smoothed by constrained relaxation [7].
(b) Each ellipse is replaced by a circle with the same area as the ellipse.
(c) The radii of these circles are replaced by a smooth (e.g. least-square) approximation of these radii. Replacing the possibly strongly varying set of radii as function of the probe number (or as function of the approximate arc length along the center line of the tube) by values of a predetermined approximation function yields a set of more smoothly varying radii. A linear function, a cubic function, a spline function or the like may be used to approximate the original data.
3. Generate the extension tube from the neck center to the second probe. We use a quadratic Bezier curve to generate the central curve of the extension tube. This Bezier curve is defined by the neck center, the position of the second probe and the normalized direction between the aneurysm center and the neck center. The remaining degree of freedom is eliminated by the arbitrary but reasonable constraint that the two sides of the control polygon have equal length. The radii of the ellipses (a shape parameter of a probe) are equal to the radii of the last ellipse (i.e. circle) of the vessel tube.
4. The corridor tube is the concatenation of the vessel tube and the extension tube. This corridor tube is also refined in a similar way as described under (a)-(c) for the vessel tube.

An example of a corridor tube (i.e. its surface) is shown in FIG. 5.5.

### 3. THE MICRO-CATHETER

We represent the shape of a micro-catheter also by a tube object. Because the micro-catheter follows the same corridor through the vessels as the catheter, and because this corridor is represented by the corridor tube, the micro-catheter tube is initialized by copying the corridor tube with all radii replaced by the radius of the micro-catheter.

The final central curve of the micro-catheter (and of the micro-catheter tube) consists of alternately straight-lined sections and curved sections. The straight-lined sections, caused by the stiffness of the micro-catheter, begin where the micro-catheter is no longer bent by the vessel wall. The curved sections begin where either a straight-lined section comes into collision with a vessel wall (left picture in FIG. 1), or where the micro-catheter follows a side branch (right picture in FIG. 1).

This final central curve of the micro-catheter tube is computed by applying a series of shift vectors to the probes of the micro-catheter in an iterative algorithm:

1. Set the begin position and direction of the next straight-lined section to the begin position and direction of the micro-catheter tube (normally the point farthest away from the aneurysm).
2. Apply a possible initial shift and update the begin position and direction of the next straight-lined section.
3. While a new begin position and direction is found Do
(a) The next straight-lined section becomes the current straight-lined section.
(b) Find the catheter corner which determines the transition of the current straight-lined section into the subsequent curved section (the arrow points in FIG. 1).
(c) Adjust the central curve of the micro-catheter tube to this catheter corner.
(d) Find the begin position and direction of the next straight-lined section.
4. Adjust the extension part of the micro-catheter tube. The extension part is the part which gets on from a “normal” vessel part through a neck into the aneurysm.

The method for finding the catheter corners which determine the transition of a straight-lined section into the subsequent curved section (the arrow points in FIG. 1), is explained in Section 3.1. The adjustment of the central curve of the micro-catheter tube to the catheter corners is described in Section 3.2. How to compute the begin position and direction of the next straight-lined section is explained in Section 3.3. Adjustment of the initial and the extension part of the micro-catheter tube is reported in Section 3.4. In Section 4, we present our results and give some conclusions to consider.

### 3.1 The Search for the Catheter Corners

The catheter corners which determine the transition of a straight-lined section into the subsequent curved section (the arrow points in FIG. 1), are found using three test probes (as already mentioned in the introduction, a probe is a combination of a sphere, a plane through the center of the sphere and a number of shape parameters). After the begin position and the direction of a straight-lined section are computed (will be explained in Section 3.3), the position of the first test probe is the begin position of this straight-lined section. The normal of the first test probe is the normalized direction of this straight-lined section. The first test probe defines also the primary test ray. The primary test ray starts at the position of the first test probe in the direction of the normal of the first test probe.

The initial position of the second test probe is given by the closest intersection of the primary test ray with the vessel surface. If no intersection is found (as is the case in the right picture of FIG. 1), the second test probe is located on the primary test ray so that the distance between the first and second test probe is equal to the largest diagonal of the surface bounding box. In this case, the second test probe is always farther away from the first test probe as any triangle vertex of the surface model of the vessel walls. The normal of the second test probe is equal to the opposite normal of the first test probe.

If the corridor tube (and thus the micro-catheter tube) follows a side branch before the primary test ray intersects the vessel wall (see FIG. 2), the second test probe is too far away from the corridor tube and thus from the future central curve of the micro-catheter tube. If in this case the initial position of the second test probe is used as catheter corner, the central curve of the micro-catheter tube would get a meander.

The second test probe is close enough to the corridor tube if there exists a corridor probe (indicated by the index k) so that the distance of this corridor probe to the plane of the second test probe is small enough:

n_{t,2}^{T}(pₖ−p_{t,2})≦rₖ×1.1 (1)

with

n_{t,2} the normal of the plane of the second test probe.

p_{t,2} the position of the sphere center of the second test probe.

pₖ the position of the sphere center of corridor probe k.

rₖ the major radius of the ellipse of corridor probe k. The factor 1.1 is used to allow for local surface irregularities.

We start the inspection with the corridor probe with index i_{begin}. This corridor probe corresponds to the begin of the current straight-lined section.

Of course, it is possible that the corridor tube between corridor probe i_{begin} and corridor probe k runs into a side branch. Therefore, the distances between the sphere centers of the inspected corridor probes and the line defined by the first and second test probe should be small enough:

(d(pᵢ;l₁₂)≦rᵢ×1.1)∀(iε[i_{begin};k]) (2)

with

l₁₂ the line between the first and second test probe.

d(pᵢ, l₁₂) the distance between pᵢ and l₁₂.

Violation of Equation 2 indicates that the central curve of the corridor tube bends away in a side branch. Correctness of Equation 1 before Equation 2 is violated, indicates that the surface of the corridor tube is close to the vessel wall in the neighborhood of the second test probe.

If the initial position of the second test probe is too far away from the corridor tube (indicating that the corridor tube follows a side branch), we need a point on the primary test ray closer to the first probe. FIG. 2 reveals that we need the intersection between the primary test ray and the extrapolated upper surface of the side branch (i.e. the surface of the side branch farthest away from the plane of the first test probe). The distance between this intersection and the first test probe, is equal to the distance between the begin of the upper surface of the side branch (i.e the point of the upper surface closest to the primary test ray) and the plane of the first test probe. Because the distance between a corridor probe in the side branch and the upper surface of the side branch, is approximately equal to the major radius of the ellipse of the corridor probe, the begin of the upper surface of the side branch can be found by checking the corridor probes for intersection with the vessel surface in the direction of the primary test ray.

We create for each corridor probe a secondary test ray. This secondary test ray starts at the position of the corridor probe checked in the direction of the normal of the first test probe (see FIG. 2). The closest intersection of a secondary test ray with the vessel surface gives the position p_{t,3} of the third test probe (i.e. a point on the upper surface) as function of the position pᵢ of the corridor probe checked (indicated by the index i) and the normal n_{t,1} of the first test probe:

p_{t,3}=p_{t,3}(pᵢ,n_{t,1}^{T}) (3)

The first corridor probe for which the distance to the corresponding plane of the third test probe is small enough (indicating that this corridor probe intersects the upper surface), gives the final position of the third test probe (see FIG. 2):

n_{t,3}^{T}(pₖ−p_{t,3}(pₖ,n_{t,1}^{T}))≦rₖ×1.1 (4)

with k the index of this corridor probe and n_{t,3} the normal of the third probe (equal to the normal of the second test probe for a consistent distance norm).

As already explained, the distance between the final position of the second test probe (and thus of the catheter corner) and the position of the first test probe is equal to the distance of the final position of the third test probe (i.e. the begin of the upper surface of the side branch) to the plane defined by the first test probe (see FIG. 2):

∥p_{t,2}−p_{t,1}∥=n_{t,1}^{T}(p_{t,3}−p_{t,1}) (5)

It is possible that there does not exists a corridor probe which fulfills Equation 4. Therefore, the search for the begin of the upper surface of the side branch is stopped if one of the following two conditions is fulfilled:

1. The distance of the corridor probe checked (indicated by the index i) to the initial plane of the second test probe is small enough:

n_{t,2}^{T}(pᵢ−p_{t,2})≦rᵢ×1.1 (6)

In this case, the central curve of the corridor tube in the side branch comes very close to the plane of the second test probe, and may be even continue at the other side of the plane of the second test probe.

2. The distance of the corridor probe checked to the line defined by the first and second test probe is too large:

d(pᵢ,l₁₂)≦2×max(rⱼ,jε[1;N_{probes}]) (7)

In this case, the central curve of the corridor tube in the side branch runs out too much from the line between the first and second probe.

If the search for the begin of the upper surface of the side branch is stopped, the distance between the final position of the second test probe and the position of the first test probe is set to the minimum of the distances of the positions of the third test probe to the plane defined by the first test probe:

∥p_{t;2}_{_{—}}p_{t;1}∥=min(n_{t,1}^{T}(p_{t,3}(pᵢ,n_{t,1}^{T})−p_{t,1})) (8)

with i the indices of the corridor probes checked.

### 3.2 Adjustment to the Catheter Corners

After a catheter corner is found, the remaining part of the micro-catheter tube has to be adjusted to this corner by applying a possibly varying shift vector to the micro-catheter probes. This remaining part begins with the micro-catheter probe corresponding to the begin of the current straight-lined section (i.e. the micro-catheter probe with index i_{begin} as used in Equation 1 and Equation 2).

Note that the preceding part of the central curve of the micro-catheter tube (i.e. the sphere centers of the micro-catheter probes with an index less than i_{begin}) is already adjusted.

The remaining part is subdivided in two pieces. The first piece is that part of the micro-catheter tube which gets on from the begin of the current straight-lined section till the catheter corner. The second piece is that part of the micro-catheter tube which gets on from the catheter corner till the end of the micro-catheter (subdivision into the first and second piece is given further detail in the sequel).

The micro-catheter tube is adjusted so that the following goals are achieved:

1. The distance between the sphere center of a micro-catheter probe and the vessel wall is approximately greater than the radius of the micro-catheter tube. Indeed, the micro-catheter tube should be practically inside the corridor tube (i.e. inside the corridor through the vessels).
2. Visual discontinuities are absent. To prevent visual discontinuities, the direction of the shift vector is kept constant.
3. The sphere centers of the micro-catheter probes are as close as possible to the sphere centers of the corresponding corridor probes. Therefore, the maximum magnitude of the shift vector should be as small as possible.
4. The central curve of the first piece is as close as possible to the straight line segment between the begin of the current straight-lined section and the catheter corner.
5. The begin part of the second piece is as close as possible to the vessel wall which bends the micro-catheter.
6. Local meanders are absent. To prevent local meanders, the magnitude of the shift vector of the second piece is monotonously decreasing as function of the index of the micro-catheter probes.
7. The connection between the first piece and the second piece is smooth.

How to subdivide the remaining part of the micro-catheter tube in a first and second piece, is described first. Next, the constrained movement of the second piece is reported. After that, adjustment of the first piece, including the smooth transition between the first and second piece, is explained.

### Subdivision in First and Second Piece

The subdivision of the remaining part of the micro-catheter tube into first and second piece is based on goal 3. After all, the maximum magnitude of the shift vector is minimal if the micro-catheter probe closest to the catheter corner (which is called “corner probe” from now on) is selected for movement to the catheter corner. In case of a hairpin bend it is possible that a probe would be selected farther away in the vessel, separated by tissue along the straight line to the catheter corner. So, we select the corner probe with index i_{corner} so that

(∥p_{icorner}−p_{t,2}∥<∥pᵢ−p_{t,2}∥)∀(iε[i_{begin},i_{corner}−1]) (9)

and

(∥p_{icorner}−p_{t,2}∥≦∥pᵢ−p_{t,2}∥)∀(iε[i_{corner}+1,i_{end}]) (10)

and

(n_{t,2}^{T}(pᵢ−p_{t,2})≧0)∀(iε[i_{begin},i_{end}]) (11)

The last equation determines the index i_{end} of the last probe used for testing.

If the first probe with index i_{begin} violates already this equation, the first probe is used as corner probe.

To get the central curve as close as possible to the catheter corner the initial shift vector should be equal to the vector between the catheter corner and the corner probe:

vᵢₙᵢₜᵢₐₗ=p_{icorner}−p_{t,2} (12)

### Constrained Movement of the Second Piece

The micro-catheter probes of the second piece are moved in the direction of the shift vector so that the micro-catheter tube keeps practically inside the corridor tube (goal 1 of Section 3.2). Note that the old position p_{old} of a micro-catheter probe, to be moved, is already acceptable, either because it is equal to the initial position, namely the sphere center of the corresponding corridor probe, or because it is the result of previous constrained movements.

A typical configuration is shown in FIG. 3 (the horizontal line segments are explained in the sequel). The old position p_{old} of the sphere center of the current micro-catheter probe, to be moved, is located between the planes of the corridor probes i_{l,old} and i_{l+1,old}. The tentative new position

p_{new}=p_{old}+v_{current} (13)

with v_{current} the current shift vector (i.e. either the initial shift vector vᵢₙᵢₜᵢₐₗ or the shift vector which gave an acceptable new position for the previous micro-catheter probe), is located between the planes of the corridor probes i_{l,new} and i_{l+1,new}.

### The Maximum Allowed Magnitude of the Shift Vector:

Computing the exact position of the intersection of the line segment p_{old}→p_{new} with the surface of the corridor tube is a very complex, error-prone and time-consuming task. Therefore, we approximate the maximum allowed magnitude of the shift vector from the projections of this line segment on the planes of the corridor probes between min(i_{l,old}; i_{l,new}) and max(i_{l+1,old}; i_{l+1,new}).

A typical projection result is shown in FIG. 4. p_{p,old} is the projection of p_{old} on the plane of the corridor probe examined, p_{p,new} is the projection of p_{new}. The center position c of the circle (will be explained in the sequel) is equal to the center position of the sphere of the corridor probe. The radius of the circle is equal to the difference between the minor ellipse radius rᵥ and the radius of the micro-catheter r_{c}.

By the way, if the projection p_{p,old} is located outside the circle (the projection should be located very close to the circle because the old position p_{old} is located practically inside the corridor tube), the projection is moved to the center of the circle until it is located inside the circle:

(∥p_{p,old}−c∥>rᵥ−r_{c})→(p_{p,old}=c+((rᵥ−r_{c})/∥p_{p,old}−c∥)·(p_{p,old}−c)) (14)

We approximate the local surface of the corridor tube in which the central curve of the micro-catheter tube should be located, by a local cylinder defined by the circle and the plane normal of the corridor probe examined (the horizontal line segments in FIG. 3 indicate the upper boundaries of these local cylinders).

In this case, the fraction of the line segment p_{old}→p_{new} between p_{old} and the intersection with this local cylinder is equal to the fraction f of the line segment p_{p,old}→p_{p,new} between p_{p,old} and the intersection with the circle. So, the maximum allowed magnitude of the shift vector from this projection is:

∥v∥ₘₐₓ=f×∥p_{new}−p_{old}∥ (15)

The intersection of the line segment p_{p,old}→p_{p,new} with the circle is given by equating the length of the vector sum to the radius of the circle:

∥(p_{p,old}−c)+f×(p_{p,new}−p_{p,old})∥=rᵥ−r_{c} (16)

For the projection result shown in FIG. 4, Equation 16 gives one positive solution for f less than 1.0. If the projection p_{p,new} is located inside the circle, Equation 16 gives one positive solution for f greater than 1.0.

If the old and new position or their projections coincide, the maximum allowed magnitude of the shift vector depends on the location of the projection p_{p,new}. If this projection is located inside the circle (the line segment p_{old}→p_{new} is then located inside the local cylinder), the current shift vector v_{current} is acceptable for the corridor probe examined. To indicate this, the maximum allowed magnitude of the shift vector is set to a value greater than the magnitude of the current shift vector. If the projection p_{p,new} is located outside the circle, the maximum allowed magnitude of the shift vector is set to zero.

For safety reasons, the final maximum allowed magnitude of the shift vector is the minimum of the values computed from the projections on the planes of the corridor probes involved.

Note that the distance between the planes of two successive corridor probes is roughly equal to the distance between two voxels. So, the error due to the approximation by local cylinders is of the same magnitude as the distance between two voxels.

### Updating the Position of the Micro-Catheter Probe:

If the maximum allowed magnitude of the shift vector ∥v∥ₘₐₓ is greater than or equal to the magnitude of the current shift vector ∥v_{current}∥, the tentative new position p_{new} becomes the final new position. If the maximum allowed magnitude of the shift vector is less than the magnitude of the current shift vector, the current shift vector is adjusted:

v_{current}=(∥v∥ₘₐₓ/∥v_{current}∥)×v_{current} (17)

and the final new position becomes:

p_{new}=p_{old}+v_{current} (18)

### Adjustment of the First Piece

After the corner probe (see Section 3.2) is moved as close as possible (see Section 3.2) to the catheter corner (see Section 3.1), possible micro-catheter probes of the first piece are moved in the same direction with a magnitude which varies linearly between the first and last probe of the first piece:

p_{i,new}=p_{i,old}+((i−i_{begin})/(i_{corner}−i_{begin}))·v_{corner}∀(iε[i_{begin},i_{corner}−1]) (19)

with v_{corner} the shift vector used to move the corner probe to the catheter corner.

Because the corner probe is as close to the catheter corner as possible and because the straight-lined section between the first probe of the first piece and the catheter corner is located inside the vessel, the shift of Equation 19 complies with goals 1, 2 and 4 of Section 3.2.

After the micro-catheter probes of the first and second piece are adjusted to the catheter corner, the whole central curve of the micro-catheter tube is smoothed by a constrained relaxation algorithm [7] to comply with goal 7 of Section 3.2. The constraints used during relaxation are that the new position p_{i,k+1} of micro-catheter probe i, proposed in iteration k should be located inside the corridor tube:

∥p_{i,k+1}−pₗ∥≦rₗ−0.9×r_{c} (20)

and

∥p_{i,k+1}−pₗ₊₁∥≦rₗ₊₁−0.9×r_{c} (21)

with the corridor probes l and l+1 selected so that the tentative new position p_{i,k+1} of the micro-catheter probe is located between the planes of these corridor probes (pₗ and pₗ₊₁ are the positions of these two corridor probes). The rather arbitrarily chosen factor 0.9 allows for better smoothing of the central curve of the micro-catheter tube because a small part of the micro-catheter tube may be located outside the corridor tube.

### 3.3 The Next Straight-Lined Section

The constrained movement described in Section 3.2 computes for each micro-catheter probe of the second piece a maximum allowed magnitude of the shift vector ∥v∥ₘₐₓ. As long as the magnitude of the current shift vector ∥v_{current}∥ is greater than or equal to the maximum allowed magnitude of the shift vector, the micro-catheter tube is bent by the vessel wall as represented by the surface of the corridor tube. The first micro-catheter probe of the second piece for which the magnitude of the current shift vector is less than the maximum allowed magnitude of the shift vector, is the first unconstrained micro-catheter probe.

We use the position of the micro-catheter probe preceding the first unconstrained micro-catheter probe as the begin position of the next straight-lined section. Because, this micro-catheter probe and its preceding micro-catheter probe are generally bent by the vessel wall, we use the normalized vector between the position of these micro-catheter probes as the direction of the next straight-lined section. Indeed, this normalized vector represents the last steering correction induced by the vessel wall before the micro-catheter leaves the vessel wall.

Note that if all micro-catheter probes of the second piece are constrained, the computation of the micro-catheter tube is finished!

### 3.4 The Extremities of the Micro-Catheter Tube

As explained in section 2, a corridor tube is the concatenation of a vessel tube (i.e. the part in the “normal” vessels up to the neck center) and an extension tube (i.e. the part from the neck center into the aneurysm). The algorithm described in the previous sections is only applied to the part of the micro-catheter tube corresponding to the vessel tube. Indeed, applying this algorithm to the part of the micro-catheter tube corresponding to the extension tube could move this part away from the selected end position in the interior of the aneurysm to the boundary the aneurysm. In fact, the extension part is stripped of from the initial micro-catheter tube (i.e. the copy of the corridor tube with the radii replaced by the micro-catheter radius) before the micro-catheter tube shaping algorithm is applied.

Because the position (and direction) of the last probe of the vessel part of the micro-catheter tube may be changed by the micro-catheter tube shaping algorithm, simply concatenation of the new micro-catheter tube with the old extension part, may result in visual discontinuities in the central curve and the surface of the micro-catheter tube. Therefore, the extension part for the micro-catheter tube is generated using the last probe of the vessel part of the micro-catheter tube.

The volumes, generated for example by 3D rotational angiography [6], contain mostly for clarity only a subset of the total vessel structure. Therefore, a corridor tube starts generally somewhere in a vessel part far away from the introducer sheath. So, the position and direction of the first corridor probe may differ from the real position and direction of the micro-catheter at that position in the vessel structure. Indeed, the bending of the vessel wall applied to the not represented preceding part of the micro-catheter may result in a position of the begin of the represented part of the micro-catheter close to the vessel wall instead of close to the central axis of the vessel.

To improve the begin position and direction of the represented part of the micro-catheter, an arbitrary initial shift vector may be applied to the micro-catheter tube (using the constrained movement algorithm described in Section 3.2) before the first catheter corner is searched for. Our demo program (as already stated, the algorithm proper allows for an arbitrary initial shift vector) contains the following five predefined initial shift vectors:

vᵢₙᵢₜᵢₐₗ=r×(u×uₐₓᵢₛ+v×vₐₓᵢₛ) (22)

(u,v)ε[(0,0),(1,0),(0,1),(−1,0),(0,−1)] (23)

with r a radius much greater than the radius of the first corridor probe and with uₐₓᵢₛ, vₐₓᵢₛ the local coordinate system in the plane of the first corridor probe.

### 4. RESULTS AND CONCLUSIONS

We have applied the method for computation of the micro-catheter tube from the corridor tube to twenty-eight clinical volume data-sets, acquired with the 3D Integris system [6]. The dimensions of the volumes are 128×128×128. Eighteen of the aneurysms are located at a bifurcation, ten are located at a single vessel part.

The averaged elapsed time for the computation of a corridor tube is 2.5 seconds on an SGI Octane (300 MHz MIPS R12000+MIPS R12010 FPU). The elapsed time for computation of the micro-catheter tube is on average 20% of the computation time for the corresponding corridor tube.

FIG. 5.4 shows the central curve, FIG. 5.6 the surface of the micro-catheter tube derived from the corridor tube with its central curve shown in FIG. 5.3 and its surface shown in FIG. 5.5.

To assess the efficiency of our method, we estimated for each micro-catheter probe i the relative distance rdᵢ between the surface of the micro-catheter tube and the surface of the corridor tube as follows:

rdᵢ=½((rₗ−(∥pₗ−p_{i,l}∥+r_{c}))/(rₗ−r_{c})+(rₗ₊₁−(∥pₗ₊₁−p_{i,l+1}∥+r_{c}))/(rₗ₊₁−r_{c})) (24)

with the corridor probes l and l+1 selected so that the position pᵢ of the micro-catheter probe is located between the planes of these corridor probes. pₗ and pₗ₊₁ are the positions, rₗ and rₗ₊₁ are the minor ellipse radii of these two corridor probes. p_{i,l}, and p_{i,l+1} are the projections of the micro-catheter probe position pᵢ onto the planes of the corridor probes.

This relative distance is negative if the micro-catheter tube is partially outside the corridor tube, zero if the surfaces coincide and positive if the micro-catheter tube is locally completely inside the corridor tube. This relative distance is equal to 1.0 (the maximum value) if the center positions of the micro-catheter tube and the corridor probe coincide (i.e. the initial state of the micro-catheter tube).

We computed the average relative distance per case and for the last four predefined initial shift vectors (see Equation 22 and 23 in Section 3.4). The statistics of these average relative distances are given in Table 1.

TABLE 1
The statistics of the average relative distances

initial shift

| | (1, 0) | (0, 1) | (−1, 0) | (0, −1) |
|---|---|---|---|---|
| minimum | 0.8% | 0.9% | 0.5% | 0.3% |
| mean | 14.2% | 12.0% | 13.1% | 14.1% |
| standard deviation | 8.9% | 5.5% | 7.6% | 9.9% |
| maximum | 39.6% | 25.2% | 30.2% | 44.0% |

The following conclusions can be drawn from the results, the pictures and the experiences gathered during testing:

1. The method to compute the micro-catheter from the corridor tube gives visually acceptable results. The clinical validation has been started in a number of clinics (clinical evaluation will be reported in a subsequent paper).
2. The relative distances (see Table 1) reveal that the efficiency of our method is statistically independent of the chosen initial shift.
3. In view of the parts of the micro-catheter tube which cross the corridor tube to the opposite side when the vessel bends back, the relative distances indicate that the efficiency of our method is quite well. However, because a “golden standard” is not (yet) available, a rough validation by visual inspection is only possible.
4. The micro-catheter tube (see FIG. 5.6) can be used as starting point for the selection and the pre-molding of the real micro-catheter for easy movement into the aneurysm.

Because our method for the computation of the micro-catheter tube from the corridor tube minimizes the inter- an intra-operator variations, it may be expected that the selected and pre-molded real micro-catheter has better quality and/or is faster available for treatment of the patient.

Finally it is pointed out that in the present application the term “comprising” does not exclude other elements or steps, that “a” or “an” does not exclude a plurality, and that a single processor or other unit may fulfill the functions of several means. The invention resides in each and every novel characteristic feature and each and every combination of characteristic features. Moreover, reference signs in the claims shall not be construed as limiting their scope.

### REFERENCES

1. J. Bruijns: “Semi-automatic shape extraction from tube-like geometry”, In Proc. VMV, pages 347-355, Saarbruecken, Germany, November 2000.
2. J. Bruijns: “Fully-automatic branch labelling of voxel vessel structures”, In Proc. VMV, pages 341-350, Stuttgart, Germany, November 2001.
3. J. Bruijns: “Fully-automatic labelling of aneurysm voxels for volume estimation”, In Proc. BVM, pages 51-55, Erlangen, Germany, March 2003.
4. R. Kemkers, J. Op de Beek, H. Aerts, R. Koppe, E. Klotz, M. Grasse, and J. Moret: “3d-rotational angiography: First clinical application with use of a standard philips c-arm system”, In Proc. CAR, Tokyo, June 1998.
5. J. Moret, R. Kemkers, J. Op de Beek, R. Koppe, E. Klotz, and M. Grass: “3d rotational angiography: Clinical value in endovascular treatment”, Medicamundi, 42(3):8-14, November 1998.
6. Philips Medical Systems Nederland. Integris 3d-ra. instructions for use. release 2.2. Technical Report 9896 001 32943, Philips Medical Systems Nederland, Best, The Netherlands, January 2001.
7. C. W. A. M. van Overveld: “Pondering on discrete smooth interpolation”, Computer-aided Design, 27(5):377-384, November 1995.

1. A method for the prediction of the course of a catheter between a starting location and a target location in a modeled vessel system, wherein the course is described by a course tube (CT, MT) running along an associated course center line (CC, MC), comprising the following steps:
a) determination of a path through the vessel system from the starting to the target location and identifying an initial course center line (MC) with said path;
b) adjusting the initial course center line such that the associated course tube (CT, MT) lies within the vessel system.

2. The method according to claim 1, characterized in that the course tube is a corridor tube (CT) that describes a corridor within which a catheter may run from the starting to the target location through the vessel system.

3. The method according to claim 1, characterized in that the course tube is a micro-catheter tube (MT) that describes the estimated shape of a micro-catheter running from the starting to the target location through the vessel system.

4. The method according to claim 2, characterized in that the corridor tube (CT) is determined first, and that a micro-catheter tube (MT) is determined next such that it lies within the corridor tube (CT).

5. The method according to claim 3, characterized in that the micro-catheter center line (MC) comprises an alternating sequence of straight-lined sections, for which the associated tube section lies in the interior of the vessel system, and of curved sections, for which the associated tube section touches the vessel wall and/or turns into a side branch of the vessel system.

6. The method according to claim 5, characterized in that the sequence is iteratively determined, preferably beginning with a straight-lined section at the starting location.

7. The method according to claim 6, characterized in that each iteration step comprises:
aa) the determination of a catheter corner as (i) the intersection of a current straight-lined section with its surrounding vessel wall or as (ii) the point on the current straight-lined section lying at the same distance from the start of said section as the farthest vessel wall of the side branch which the micro-catheter follows;
bb) shifting a point of the current straight-lined section that is close to the catheter corner by an initial shift vector towards the catheter corner; and
cc) introducing a transition from the current straight-lined section to the following curved section at the aforementioned shifted point.

8. The method according to claim 7, characterized in that the micro-catheter center line (MC) of the following curved section is piece by piece shifted in the direction of the initial shift vector with the shift length being monotonously reduced such that the associated tube contacts the wall of the vessel system, wherein the following straight-lined section starts where contact to the vessel wall is lost.

9. The method according to claim 1, characterized in that a tube through the vessel system is modeled by probes that comprise a sphere with its center lying on the center line of the tube and with a plane that comprises said center and runs orthogonal to the center line of the tube.

10. A method for the manufacture of a catheter, particularly a micro-catheter, comprising
a) the prediction of the course of the catheter with a method according to claim 1, and
b) the preparation of the catheter according to the predicted course.

11. A data processing unit which is adapted to execute a method according to claim 1.

12. A record carrier on which a computer program for the prediction of the course of a catheter is stored, said program being adapted to execute a method according to claim 1.
